(19) United States
(12) Patent Application Publication
(10) Pub. No.: US 2021/0331579 A1
(43) Pub. Date: Oct. 28, 2021

(54) HEAT EXCHANGER

(71) Applicant: DENSO CORPORATION, Kariya-city (JP)

(72) Inventor: Fumihiko USUKI, Kariya-city (JP)

(21) Appl. No.: 17/369,647

(22) Filed: Jul. 7, 2021

Related U.S. Application Data
(63) Continuation of application No. PCT/JP2020/000491, filed on Jan. 9, 2020.

(30) Foreign Application Priority Data
Feb. 6, 2019 (JP) 2019-020001

(51) Int. Cl. B60K 11/04; F28F 9/26; F28F 1/12

(52) U.S. Cl. CPC B60K 11/04; B60K 11/08; F28F 1/126; F28F 9/262

(57) ABSTRACT

A heat exchanger is arranged at one side in a predetermined direction with respect to a wall body having a ventilation opening. A core portion includes a plurality of tubes in which a heat medium flows to exchange heat with air having passed through the ventilation opening. A first header tank is connected to one ends of the plurality of tubes, and is provided with an inflow port from which the heat medium flows into the first header tank. The other ends of the plurality of tubes are connected to a second header tank, and the heat medium flowing through the tubes collects into the second header tank. The core portion has an opening overlapping range that overlaps with the ventilation opening at the one side in the predetermined direction, and a large amount of the heat medium flows unevenly into the opening overlapping range of the entire core portion.

### CROSS REFERENCE TO RELATED APPLICATION

The present application is a continuation application of International Patent Application No. PCT/JP2020/000491 filed on Jan. 9, 2020, which designated the U.S. and claims the benefit of priority from Japanese Patent Application No. 2019-020001 filed on Feb. 6, 2019. The entire disclosures of all of the above applications are incorporated herein by reference.

### TECHNICAL FIELD

The present disclosure relates to a heat exchanger that exchanges heat between air and a heat medium.

### BACKGROUND

For example, a cooling system includes first to third air-cooled heat exchangers each of which is a heat exchanger. For example, a core width of the third air-cooled heat exchanger is made narrower than a core width of the first air-cooled heat exchanger. The third air-cooled heat exchanger is configured to be inserted between coolant tanks of the first air-cooled heat exchanger. Therefore, the cooling system can be made thin in an air flow direction to be compactly configured.

In recent years, in electric vehicles, a grill opening of a front grill provided in front of the vehicle has become smaller in order to reduce air resistance during traveling. In this case, it becomes difficult for the cooling air to evenly supply throughout the core portion in the heat exchanger arranged on the downstream side of the air flow with respect to the front grill.

### SUMMARY

The present disclosure provides a heat exchanger capable of increasing the heat exchange efficiency when the air volume distribution of the air passing through the core portion is uneven.

According to an aspect of the present disclosure, a heat exchanger is arranged at one side in a predetermined direction with respect to a wall body having a ventilation opening through which air flows to the one side in the predetermined direction. The core portion includes a plurality of tubes in which a heat medium flows to exchange heat with air having passed through the ventilation opening of the wall body.

The first header tank is connected to one ends of the plurality of tubes, and is provided with an inflow port from which the heat medium flows into the first header tank. The other ends of the plurality of tubes are connected to the second header tank, and the heat medium flowing through the plurality of tubes flows into the second header tank. The core portion has an opening overlapping range that overlaps the ventilation opening at the one side of the wall body, and the opening overlapping range is a partial range of the all core portion. In addition, the inflow port is arranged in the first header tank to cause the heat medium to flow with a large amount unevenly in the opening overlapping range within the entire core portion.

### BRIEF DESCRIPTION OF THE DRAWINGS

The above and other objects, features and advantages of the present disclosure will become more apparent from the following detailed description made with reference to the accompanying drawings.

FIG. 1 is a diagram schematically showing a radiator and its surroundings in a vehicle equipped with the radiator according to a first embodiment.

FIG. 2 is a schematic view showing a front surface of the radiator of the first embodiment.

FIG. 3 is a diagram corresponding to FIG. 1, schematically showing a radiator and its surroundings in a vehicle equipped with the radiator, according to a comparative example of the first embodiment.

FIG. 4 is a schematic view corresponding to FIG. 2, showing a front surface of a radiator according to a second embodiment.

### DESCRIPTION OF EMBODIMENTS

A grill opening of a front grill provided in front of the vehicle may be made smaller in order to reduce air resistance during traveling. When the grill opening becomes small in this way, it becomes difficult for the cooling air to evenly supply throughout the core portion in the heat exchanger arranged on the downstream side of the air flow with respect to the front grill.

Further, depending on the installation location of the inflow port from which the heat medium flows in the heat exchanger, the distribution of the heat medium in the core portion of the heat exchanger may be biased. For example, when a flow rate distribution of the heat medium in the core portion of the heat exchanger deviates significantly from the air volume distribution of the cooling air passing through the core portion, heat exchange efficiency in the heat exchanger is reduced. The above-described facts have been found by detail studies of the inventor of the present disclosure.

According to the detail studies of the inventor of the present disclosure, a flow rate distribution of the heat medium in the core portion can be set at a distribution in which the flow rate of the heat medium in the opening overlapping range becomes larger in accordance with the increase of the air volume passing through the opening overlapping range within the core portion. In this case, it is possible to increase the heat exchange efficiency in the heat exchange between the heat medium and the air, as compared with a case where the flow rate distribution of the heat medium is made uniform in the entire core portion.

Hereinafter, embodiments will be described with reference to the drawings. In the following embodiments, the same reference numeral is given to the same or equivalent parts in the drawings.

### First Embodiment

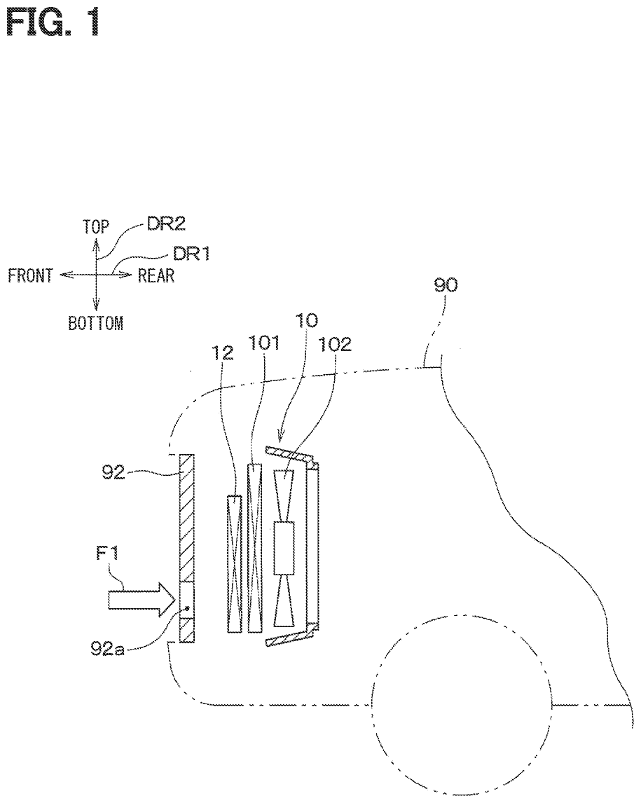

As shown in FIG. 1, a radiator 12 that is a heat exchanger of this embodiment constitutes a part of a cooling system 10 mounted on a vehicle 90. In the present embodiment, the vehicle 90 is an electric vehicle that does not have an engine and runs by a motor.

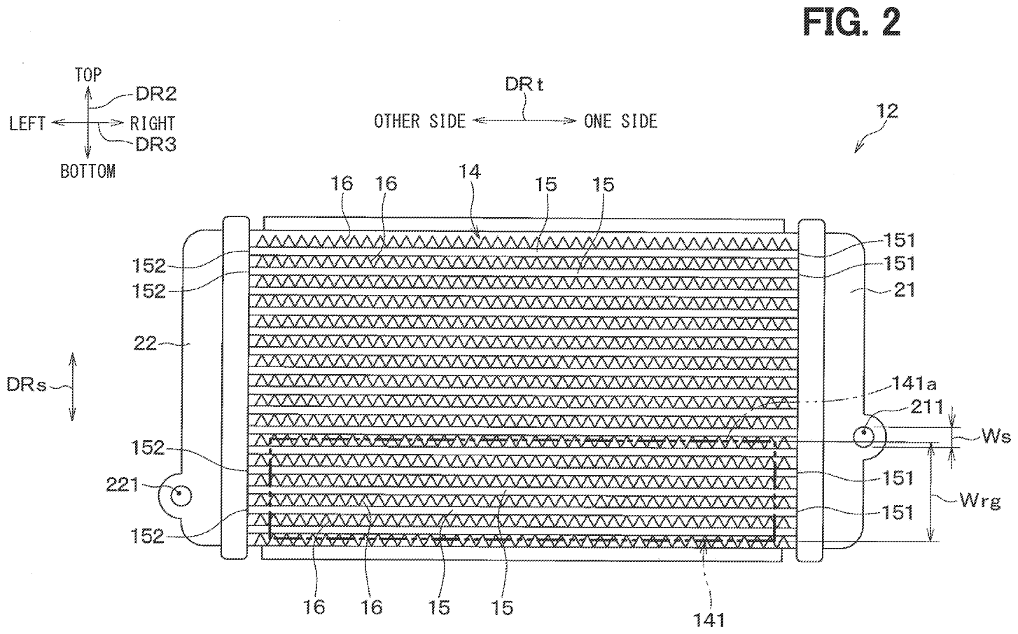

The cooling system 10 of FIG. 1 is provided in a front portion of the vehicle 90, and is arranged behind a front grill 92 of the vehicle 90 in a vehicle front-rear direction DR1. The arrows DR1, DR2, and DR3 in FIGS. 1 and 2 indicate the directions of the vehicle 90. That is, the arrow DR1 in FIG. 1 represents a front-rear direction DR1 of the vehicle, and the arrow DR2 represents an up-down direction DR2 (i.e., vertical direction) of the vehicle. In FIG. 2, the arrow DR3 represents a left-right direction DR3 of the vehicle, i.e. a width direction DR3 of the vehicle. The directions DR1, DR2, DR3 intersect with each other. Specifically, the directions DR1, DR2, DR3 are orthogonal to each other.

The front grill 92 is a wall-shaped wall body arranged so as to be exposed to the outside of the vehicle toward the front of the vehicle. The front grill 92 is provided with a ventilation opening 92a which is a through hole penetrating through the front grill 92 in the vehicle front-rear direction DR1.

Therefore, as shown by the arrow F1 in FIG. 1, the traveling wind, which is the air flowing in one side of a predetermined direction as a downstream side of the air flow, passes through the ventilation opening 92a of the front grill 92, and flows to a downstream air side with respect to the front grill 92. For example, the predetermined direction is the vehicle front-rear direction DR1 in FIG. 1, and the one side of the predetermined direction is the rear side of the vehicle front-rear direction DR1. The traveling wind cannot pass through the portion of the front grill 92 other than the ventilation opening 92a.

In addition to the radiator 12, the cooling system 10 includes a condenser 101 that forms a part of a refrigeration cycle device for an air-conditioning of the vehicle interior, and a blower 102. The radiator 12 is arranged behind the front grill 92 in the vehicle front-rear direction DR1. Further, the condenser 101 is arranged behind the radiator 12 in the vehicle front-rear direction DR1. In addition, the blower 102 is arranged behind the condenser 101 in the vehicle front-rear direction DR1.

The blower 102 is appropriately operated in accordance a condition. The blower 102 generates an air flow from the front side to the rear side of the vehicle front-rear direction DR1 by its operation, and causes the air to flow through the radiator 12 and the condenser 101 in this order.

The radiator 12 of the present embodiment is a low-temperature water radiator for cooling an inverter or a battery mounted on the vehicle 90. A heat medium circulating in the radiator 12 is a liquid coolant, and cooling water is used as the heat medium in the present embodiment, for example. The radiator 12 releases the heat of the cooling water to the outside air by exchanging heat between the cooling water and the traveling wind which is the outside cooling air. Therefore, the traveling wind functions as a cooling air for cooling the cooling water. The circulation of the cooling water of the radiator 12 is performed by, for example, an electric water pump (not shown).

As shown in FIG. 2, the radiator 12 has a core portion 14, a first header tank 21, and a second header tank 22.

The core portion 14 of the radiator 12 includes a plurality of tubes 15 and a plurality of fins 16. The core portion 14 is a heat exchanging portion of the radiator 12, which exchanges heat between air (for example, traveling wind) and cooling water flowing in a plurality of tubes 15.

The plurality of tubes 15 and the plurality of fins 16 are arranged so as to be alternately stacked in the tube stacking direction DRs. The tube stacking direction DRs corresponds to the vehicle top-bottom direction DR2 in this embodiment.

Each of the plurality of tubes 15 is, for example, an aluminum alloy tube having a flat cross-sectional shape, and is enlarged in a tube extension direction DRt. The tube extension direction DRt corresponds to the vehicle width direction DR3 in this embodiment.

A coolant (e.g., cooling water) circulates inside the tubes 15, and air (e.g., traveling wind) to be heat-exchanged with the cooling water passes through spaces between the tubes 15. The tube 15 includes a first tube end 151 located on one side of the tube extending direction DRt (that is, the right side of the vehicle width direction DR3 in FIG. 2), and a second tube end 152 located on the other side of the tube extending direction DRt (that is, the left side of the vehicle width direction DR3).

The fin 16 is, for example, a corrugated fin formed by a thin plate made of an aluminum alloy. The fin 16 is used to promote heat exchange between the cooling water flowing in the tube 15 and the air.

With such a configuration, the core portion 14 exchanges heat between the air (for example, traveling wind) that has passed through the ventilation opening 92a of the front grill 92 and the cooling water flowing in the plurality of tubes 15.

The first header tank 21 is arranged at one side of the tube extending direction DRt (that is, at the right side of the vehicle width direction DR3) with respect to the core portion 14. The first tube end 151 of each of the tubes 15 is connected to the first header tank 21. The first header tank 21 has a shape extending in the tube stacking direction DRs.

Further, an internal space is formed in the first header tank 21, and the internal space of the first header tank 21 communicates with all the tubes 15. Further, the first header tank 21 is provided with an inflow port 211 from which cooling water flows into the internal space of the first header tank 21.

A cooling water supply pipe that supplies cooling water to the radiator 12 is connected to the inflow port 211 of the first header tank 21. Therefore, the cooling water flows through the internal space of the first header tank 21, and the first header tank 21 is configured to distribute the cooling water supplied from the cooling water supply pipe to each tube 15.

The second header tank 22 is arranged at the other side of the tube extending direction DRt (that is, at the left side of the vehicle width direction DR3) with respect to the core portion 14. The second tube end 152 of each of the tubes 15 is connected to the second header tank 22. The second header tank 22 has a shape extending in the tube stacking direction DRs.

Further, an internal space is formed in the second header tank 22, and the internal space of the second header tank 22 communicates with all the tubes 15. Further, the second header tank 22 is provided with an outflow port 221 communicating with the internal space of the second header tank 22, so that the cooling water of the second header tank 22 flows out from the outflow port 221. The outflow port 221 is arranged below the inflow port 211 in the vehicle top-bottom direction DR2 (i.e., vehicle vertical direction).

A cooling water outflow pipe that allows the cooling water to flow out from the radiator 12 is connected to the outflow port 221 of the second header tank 22. Therefore, the cooling water from the tubes flows through the internal space of the second header tank 22, and the second header tank 22 is configured to collect the cooling water flowing from each tube 15 and to cause the cooling water to flow out to the outside of the radiator 12.

When the radiator 12 is configured as described above, the cooling water as a heat medium flowing into the first header tank 21 from the inflow port 211 is distributed to the tubes 15 at the first header tank 21. The distributed cooling water from the first header tank 21 flows through the tubes 15, and collects into the second header tank 22. Then, the cooling water collected in the second header tank 22 flows out from the outflow port 221 to the outside of the radiator 12 (specifically, the cooling water outflow pipe).

As shown in FIGS. 1 and 2, the front grill 92 is arranged at the front side of the vehicle front-rear direction DR1 with respect to the radiator 12. Therefore, the core portion 14 has an opening overlapping range 141 that overlaps the entire area of the ventilation opening 92a of the front grill 92 on the rear side of the vehicle front-rear direction DR1. The opening overlapping range 141 is a partial range within the core portion 14 of the radiator 12. In other words, the opening overlapping range 141 is a projection range obtained by projecting the ventilation opening 92a on the radiator 12 along the vehicle front-rear direction DR1. For example, in the present embodiment, the opening overlapping range 141 is formed within a range of the core portion 14 that is biased downward in the vehicle top-bottom direction DR2. In FIG. 2, the opening overlapping range 141 is formed below the center position of the core portion 14 in the vehicle top-bottom direction DR2.

Since the opening overlapping range 141 is a partial range of the entire core portion 14, the traveling wind passing through the ventilation opening 92a of the front grill 92 does not spread evenly over the entire core portion 14, and air volume of the traveling wind passing through the core portion 14 is biased. Specifically, a large amount of traveling wind passing through the ventilation opening 92a flows unevenly and mainly in the opening overlapping range 141 of the core portion 14.

In the present embodiment, the inflow port 211 of the first header tank 21 is arranged so that a larger amount of cooling water flows unevenly and mainly in the opening overlapping range 141 of the entire core portion 14, than the other range of the core portion 14. The outflow port 221 of the second header tank 22 is also arranged in the same manner as that of the inflow port 211. That is, the inflow port 211 and the outflow port 221 of the present embodiment are arranged so that a large amount of cooling water flows unevenly and mainly in the opening overlapping range 141 of the entire core portion 14.

In the present embodiment, the location position of the inflow port 211 in the first header tank 21 is set at a position where a large amount of cooling water flows mainly in the opening overlapping range 141 of the entire core portion 14. Similarly, the location position of the outflow port 221 in the second header tank 22 is set at a position where a large amount of cooling water flows mainly in the opening overlapping range 141 of the entire core portion 14.

Specifically, at least a part of the inflow port 211 is located within the width Wrg occupied by the opening overlapping range 141 in the tube stacking direction DRs, that is, within the width Wrg (dimension) of the opening overlapping range 141 in the tube stacking direction. Thus, the inflow port 211 of the present embodiment is arranged so that a large amount of cooling water flows unevenly and mainly in the opening overlapping range 141 of the entire core portion 14.

In the present embodiment, the inflow port 211 is arranged so that the cooling water flows with a large amount unevenly in the opening overlapping range 141 within the entire core portion 14. That is, at least a part of the inflow port 211 is positioned within the width Wrg of the opening overlapping range 141 in the tube stacking direction DRs. In FIG. 2, not all but a part of the inflow port 211 is located within the width Wrg (dimension) of the opening overlapping range 141 in the tube stacking direction DRs.

In other words, the position of an upper end 141a of the opening overlapping range 141 in the vehicle top-bottom direction DR2 is within the width Ws (that is, the vertical width Ws of the inflow port 211) of the inflow port 211 in the vehicle top-bottom direction DR2. Thus, the inflow port 211 of the present embodiment is arranged so that a large amount of cooling water flows unevenly and mainly in the opening overlapping range 141 of the entire core portion 14.

In the present embodiment, the inflow port 211 is arranged so that the cooling water flows with a large amount unevenly in the opening overlapping range 141 within the entire core portion 14. That is, the position of the upper end 141a of the opening overlapping range 141 in the vehicle top-bottom direction DR2 is set within the width Ws of the inflow port 211 in the top-bottom direction DR2.

In addition, the inflow port 211 and the outflow port 221 are located lower than the center position of the core portion 14 in the vehicle top-bottom direction DR2, in accordance with the position of the opening overlapping range 141. Thus, the inflow port 211 and the outflow port 221 of the present embodiment are arranged so that a large amount of cooling water flows unevenly and mainly in the opening overlapping range 141 of the entire core portion 14.

In the present embodiment, the inflow port 211 and the outflow port 221 are arranged so that the cooling water flows with a large amount unevenly and mainly in the opening overlapping range 141 within the entire core portion 14. That is, the inflow port 211 and the outflow port 221 are located below the center position of the core portion 14 in the vehicle top-bottom direction DR2.

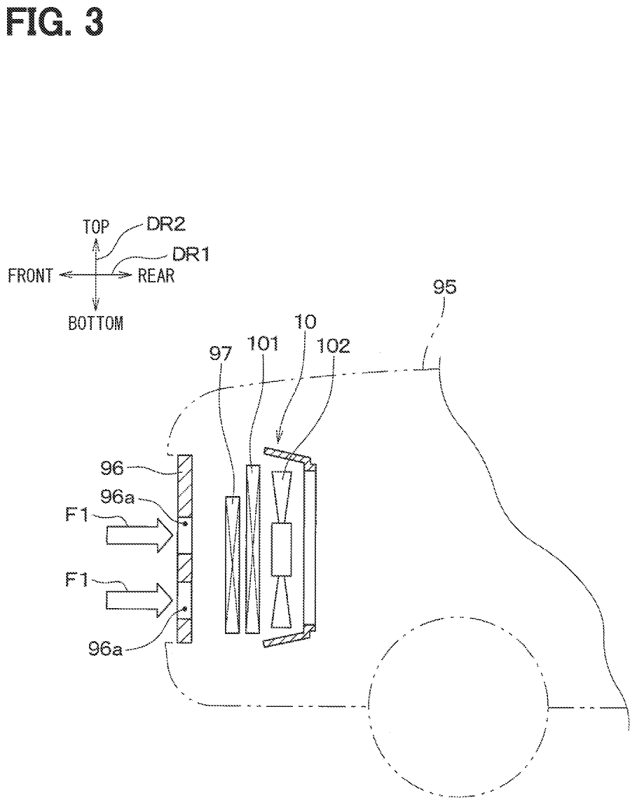

Here, a comparative example of FIG. 3 for comparison with the present embodiment will be described. As shown in FIG. 3, a vehicle 95 of the comparative example is also provided with a front grill 96 corresponding to the front grill 92 of the present embodiment and a radiator 97 corresponding to the radiator 12 of the present embodiment. However, in the comparative example shown in FIG. 3, the front grill 96 is provided with a plurality of ventilation openings 96a so as to be totally and largely open to the core portion of the radiator 97.

In contrast, in the present embodiment, as shown in FIGS. 1 and 2, the ventilation opening 92a of the front grill 92 is only partially open in a limited area with respect to the core portion 14 of the radiator 12, at the front side of the vehicle front-rear direction DR1 with respect to the radiator 12. In the radiator 12 of the present embodiment, the core portion 14 has the opening overlapping range 141 that overlaps the entire area of the ventilation opening 92a of the front grill 92 on the rear side of the front grill 92 in the vehicle front-rear direction DR1. The opening overlapping range 141 is a partial range within the core portion 14 of the radiator 12. In addition, the inflow port 211 of the first header tank 21 is arranged so that a large amount of the cooling water flows unevenly and mainly in the opening overlapping range 141 of the entire core portion 14.

As a result, a flow rate distribution of the cooling water in the core portion 14 can be set at a distribution in which the flow rate of the cooling water in the opening overlapping range 141 becomes larger in accordance with the increase of the air volume passing through the core portion 14 in the opening overlapping range 141. Therefore, it is possible to increase the heat exchange efficiency in the heat exchange between the cooling water and the air, as compared with a case where the flow rate distribution of the cooling water is uniform in the entire core portion 14.

Further, as compared with the case where the flow rate distribution of the cooling water is uniform in the entire core portion 14, the flow velocity of the cooling water in the opening overlapping range 141 is higher due to the deviation of the flow rate distribution of the cooling water. Therefore, in the opening overlapping range 141, the heat transfer coefficient between the tube 15 and the cooling water becomes higher. As a result, it is possible to increase the heat exchange efficiency in the heat exchange between the cooling water and the air, as compared with the case where the flow rate distribution of the cooling water is uniform in the entire core portion 14.

By increasing the heat exchange efficiency of the radiator 12 in this way, the following advantages can be obtained. For example, according to the present embodiment, the size of the radiator 12 can be reduced, and the weight of the radiator 12 alone and the weight of the cooling water in the radiator 12 can be reduced to save power when the vehicle is traveling. In addition, it is possible to reduce the size of the water pump that circulates the cooling water, to reduce the weight of the water pump, and further to save the power when the vehicle is traveling. Further, the discharge flow rate of the water pump can be reduced to suppress the power consumption of the water pump, and the traveling performance of the vehicle 90, particularly the cruising distance, can be improved.

Because the decrease in the discharge flow rate of the water pump causes a decrease in the pressure of the cooling water, it is possible to design a pipe or the like, through which the cooling water flows, with a reduced pressure resistance. By designing with such a reduced pressure resistance, the pressure resistance of the hose included in the pipe for flowing cooling water can be reduced and the thickness of the reserve tank can be reduced. Therefore, it is possible to effectively reduce the cost.

Furthermore, according to the present embodiment, the inflow port 211 and the outflow port 221 are arranged so that a large amount of cooling water flows unevenly and mainly in the opening overlapping range 141 in the entire core portion 14. Therefore, as compared with a case where the outlet 221 is arranged regardless of the flow rate distribution of the cooling water in the core portion 14, it is possible to circulate a large amount of cooling water into the opening overlapping range 141 in the core portion 14.

According to the present embodiment, at least a part of the inflow port 211 is positioned within the width Wrg of the opening overlapping range 141 in the tube stacking direction DRs. Because the inflow port 211 is arranged near the opening overlapping range 141, it is possible to bias the cooling water to flow easily in the opening overlapping range 141 of the core portion 14 with a large flow rate.

For example, in the present embodiment, the opening overlapping range 141 is formed within a range of the core portion 14, biased downward in the vehicle top-bottom direction DR2. The inflow port 211 is located below the center position of the core portion 14 in the vehicle top-bottom direction DR2. Thus, due to the synergistic effect of the inflow port 211 being arranged near the opening overlapping range 141 and the gravity acting on the cooling water, the cooling water flow can be easily biased to the opening overlapping range 141 within the entire core portion 14, and thereby a large amount of the cooling water flows through the tubes 15 in the opening overlapping range of the core portion 14.

Further, according to the present embodiment, not only the inflow port 211 but also the outflow port 221 is located below the center position of the core portion 14 in the vehicle top-bottom direction DR2. Thus, due to the synergistic effect of the inflow port 211 and outflow port 221 being arranged near the opening overlapping range 141 and the gravity acting on the cooling water, the cooling water flow can be easily biased to the opening overlapping range 141 within the entire core portion 14, and thereby a large amount of the cooling water flows through the tubes 15 in the opening overlapping range of the core portion 14.

Further, because the difference between the position of the inflow port 211 and the position of the outflow port 221 in the vehicle top-bottom direction is reduced, the flow velocity of the cooling water in the opening overlapping range 141 of the core portion 14 can be increased, and the heat transfer coefficient between the tube 15 and the cooling water can be increased in the opening overlapping range 141 of the core portion 14. Thus, it is possible to increase the heat exchange rate in the heat exchange between the cooling water and the air in the radiator 12. In particular, in the present embodiment, because the opening overlapping range 141 is formed in a range of the core portion 14, biased downward in the vehicle top-bottom direction DR2, the above-mentioned effect is remarkable due to the gravity of the cooling water.

Further, according to the present embodiment, the position of the upper end 141a of the opening overlapping range 141 is positioned within the width Ws of the inflow port 211 in the vehicle top-bottom direction DR2. Thus, due to the synergistic effect of the inflow port 211 being arranged near the opening overlapping range 141 and the gravity acting on the cooling water, the cooling water flow can be easily biased to the opening overlapping range 141 within the entire core portion 14, and thereby a large amount of the cooling water flows through the tubes 15 in the opening overlapping range of the core portion 14. Then, the cooling water entering from the inflow port 211 can be easily distributed from the upper portion of the opening overlapping range 141 to the entire opening overlapping range 141 by using gravity.

### Second Embodiment

A second embodiment of the present disclosure will be described next. The present embodiment will be explained mainly with respect to portions different from those of the first embodiment. In addition, explanations of the same or equivalent portions as those in the above embodiment will be omitted or simplified. The same applies to a description of embodiments as described later.

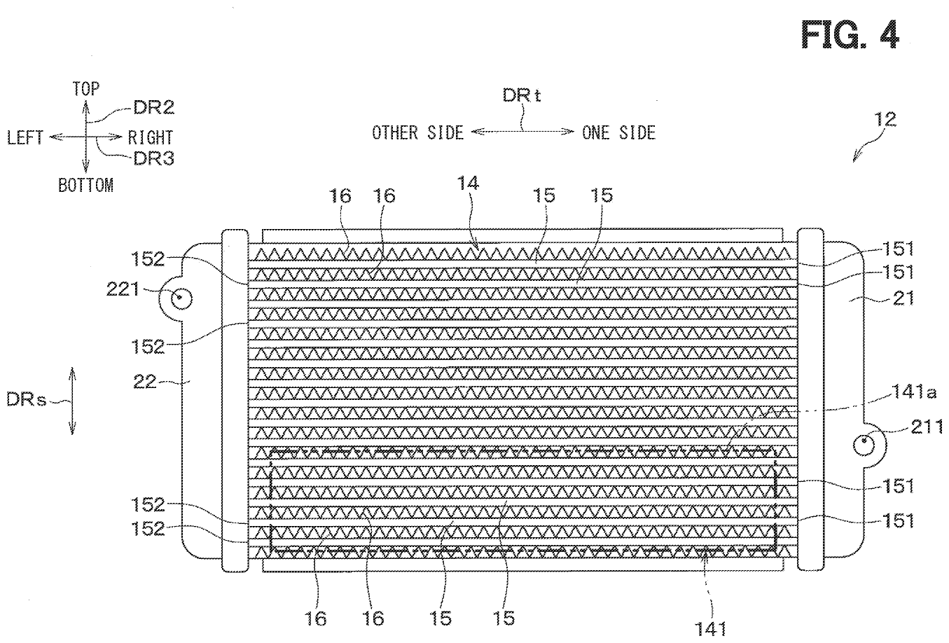

As shown in FIG. 4, in a radiator 12 of the present embodiment, the arrangement of the inflow port 211 and the arrangement of the opening overlapping range 141 of the core portion 14 are the same as those of the first embodiment. However, the arrangement position of the outflow port 221 of the present embodiment is different from that of the first embodiment.

Specifically, in the present embodiment, the outflow port 221 is located above the center position of the core portion 14 in the vehicle top-bottom direction DR2. The inflow port 211 of the present embodiment is arranged so that a large amount of cooling water flows unevenly and mainly in the opening overlapping range 141 within the entire core portion 14. In the second embodiment, the outflow port 221 is not arranged in the opening overlapping range 141 of the core portion 14 in the vehicle top-bottom direction, but is arranged above the opening overlapping range 141 of the core portion 14 in the vehicle top-bottom direction.

The other parts of the present embodiment are similar to those of the first embodiment. Thus, in the present embodiment, the same effects as the first embodiment described above can be obtained in the same manner as in the first embodiment.

### Other Embodiments

(1) In the above-described first embodiment, as shown in FIG. 2, a part of the inflow port 211 is positioned within the width Wrg of the opening overlapping range 141 in the tube stacking direction DRs, but this is an example. For example, all area of the inflow port 211 can be positioned within the width Wrg of the opening overlapping range 141 in the tube stacking direction DRs.

(2) In each of the above-described embodiments, as shown in FIGS. 1 and 2, the heat exchanger of the present disclosure is a radiator 12 that exchanges heat between the traveling wind and the cooling water, but is not limited thereto. For example, the heat medium circulating in the tube 15 may be a fluid other than cooling water, and the air to be exchanged with the heat medium may ne a fluid other than the traveling wind. Further, the arrangement direction of the front grill 92 and the radiator 12 in the present disclosure does not have to be the vehicle front-rear direction DR1.

(3) In each of the above-described embodiments, as shown in FIG. 1, the vehicle 90 on which the radiator 12 is mounted is an electric vehicle, but the present invention is not limited to this. For example, the vehicle 90 may be a hybrid vehicle or an engine vehicle having a traveling engine but not a traveling motor.

(4) In each of the above-described embodiments, as shown in FIG. 1, the condenser 101 is arranged at the rear side of the vehicle front-rear direction DR1 with respect to the radiator 12. For example, the condenser 101 may be arranged between the front grill 92 and the radiator 12 in the vehicle front-rear direction DR1. That is, the condenser 101 may be arranged at the front side of the vehicle front-rear direction DR1 with respect to the radiator 12. Alternatively, the condenser 101 may be not provided.

(5) The present disclosure is not limited to the embodiments described above, but can be variously modified. Further, in each of the above-mentioned embodiments, it goes without saying that components of the embodiment are not necessarily essential except for a case in which the components are particularly clearly specified as essential components, a case in which the components are clearly considered in principle as essential components, and the like.

Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the embodiments described above, when referring to the material, shape, positional relationship, and the like of the components and the like, except in the case where the components are specifically specified, and in the case where the components are fundamentally limited to a specific material, shape, positional relationship, and the like, the components are not limited to the material, shape, positional relationship, and the like.

### (Overview)

According to an aspect shown in a part or all of the above embodiments, a heat exchange is located at one side in a predetermined direction with respect to a wall body having a ventilation opening through which air flows to the one side as a downstream side of the air flow. Then, an inflow port into which the heat medium flows is formed in the first header tank, and the inflow port is arranged so that the heat medium flows with a larger amount unevenly in the opening overlapping range within the entire core portion, than the other portion of the core portion.

For example, a heat exchanger mounted to a vehicle at a vehicle rear side of a wall body having a ventilation opening through which air flows to the vehicle rear side includes: a core portion including a plurality of tubes in which a heat medium flows to exchange heat with air having passed through the ventilation opening of the wall body, the plurality of tubes being stacked in a tube stacking direction; a first header tank connected to one ends of the plurality of tubes to distribute the heat medium into the plurality of tubes, and being provided with an inflow port from which the heat medium flows into the first header tank; and a second header tank connected to the other ends of the plurality of tubes, into which the heat medium flowing through the tubes collects.

The core portion has an opening overlapping range that overlaps the ventilation opening at the vehicle rear side of the ventilation opening, the opening overlapping range is a partial range of the core portion in the tube stacking direction, and at least a part of the inflow port is arranged in an area of the first header tank corresponding to the opening overlapping range of the core portion in the tube stacking direction.

The second header tank is provided with an outflow port from which the heat medium collected in the second header tank flow out, and at least a part of the outflow port is arranged in an area of the second header tank corresponding to the opening overlapping range of the core portion in the tube stacking direction.

Further, according to another aspect, an outflow port through which the heat medium flows out is formed in the second header tank. The inflow port and the outflow port are arranged so that the heat medium flows with a larger amount unevenly in the opening overlapping range within the entire core portion, than the other portion of the core portion. Therefore, as compared with a case where the outlet is arranged regardless of the flow rate distribution of the heat medium in the core portion, it is possible to circulate a large amount of the heat medium into the opening overlapping range in the core portion.

Further, according to another aspect, the plurality of tubes are laminated in a tube stacking direction intersecting the predetermined direction. Then, at least a part of the inflow port is positioned within the width of the opening overlapping range in the tube stacking direction. Because the inflow port is arranged near the opening overlapping range in the tube stacking direction, it is possible to bias the heat medium to flow in the opening overlapping range of the core portion with a large flow rate.

Further, according to another aspect, the heat exchanger is mounted on the vehicle. In this case, the heat medium is a liquid, the predetermined direction intersects the vehicle top-bottom direction (vertical direction), and the plurality of tubes are laminated in the tube stacking direction corresponding to the vehicle top-bottom direction. The opening overlapping range is formed as a range of the core portion that is biased downward in the vehicle top-bottom direction, and the inflow port is located below a central position of the core portion in the vehicle top-bottom direction. Thus, due to the synergistic effect of the inflow port being arranged near the opening overlapping range and the gravity acting on the heat medium, the heat medium flow can be easily biased to the opening overlapping range within the entire core portion, and thereby a large amount of the heat medium flows through the tubes in the opening overlapping range of the core portion.

Further, according to another aspect, the heat exchanger may be mounted on the vehicle. In this case, the heat medium is a coolant, the predetermined direction intersects the vehicle top-bottom direction (vertical direction), and the plurality of tubes are laminated in the tube stacking direction corresponding to the vehicle top-bottom direction. The opening overlapping range is formed as a range of the core portion that is biased downward in the vehicle top-bottom direction, and the inflow port and the outflow port are located below the central position of the core portion in the vehicle top-bottom direction. Thus, due to the synergistic effect of the inflow port and outflow port being arranged near the opening overlapping range and the gravity acting on the cooling water, the cooling water flow can be easily biased to the opening overlapping range within the entire core portion, and thereby a large amount of the cooling water flows through the tubes in the opening overlapping range of the core portion.

Further, according to another aspect, the heat exchanger may be mounted on the vehicle. In this case, the heat medium is a coolant, the predetermined direction intersects the vehicle top-bottom direction (vertical direction), and the plurality of tubes are laminated in the tube stacking direction corresponding to the vehicle top-bottom direction. The opening overlapping range is formed as a range of the core portion that is biased downward in the vertical direction, and the position of the upper end of the opening overlapping range in the vehicle top-bottom direction is positioned within the width of the inflow port in the vehicle top-bottom direction. Thus, due to the synergistic effect of the inflow port being arranged near the opening overlapping range and the gravity acting on the heat medium, the heat medium flow can be easily biased to the opening overlapping range within the entire core portion, and thereby a large amount of the heat medium flows through the tubes in the opening overlapping range of the core portion.

What is claimed is:

1. A heat exchanger to be arranged at one side in a predetermined direction with respect to a wall body having a ventilation opening through which air flows to the one side in the predetermined direction, the heat exchanger comprising:
a core portion including a plurality of tubes in which a heat medium flows to exchange heat with air having passed through the ventilation opening;
a first header tank connected to one ends of the plurality of tubes, and being provided with an inflow port from which the heat medium flows into the first header tank; and
a second header tank connected to the other ends of the plurality of tubes, into which the heat medium flowing through the tubes flows, wherein
the core portion has an opening overlapping range that overlaps the ventilation opening at the one side of the wall body, in a partial range of the core portion, and
the inflow port is arranged in the first header tank to cause the heat medium to flow with a large amount unevenly in the opening overlapping range within the entire core portion.

2. The heat exchanger according to claim 1, wherein
the second header tank is provided with an outflow port through which the heat medium in the second header tank flows out, and
the inflow port and the outflow port are arranged to cause the heat medium to flow with a large amount unevenly in the opening overlapping range within the entire core portion.

3. The heat exchanger according to claim 1, wherein
the plurality of tubes are laminated in a tube stacking directions intersecting the predetermined direction, and
at least a part of the inflow port is located within a width dimension of the opening overlapping range in the tube stacking direction.

4. The heat exchanger according to claim 1, wherein
the wall body is mounted on a vehicle,
the heat medium is a liquid medium,
the predetermined direction is a direction that intersects a vehicle top-bottom direction,
the plurality of tubes are laminated in the vehicle top-bottom direction,
the opening overlapping range is a range of the core portion, biased downward in the vehicle top-bottom direction, and
the inflow port is located below a center position of the core portion in the vehicle top-bottom direction.

5. The heat exchanger according to claim 2, wherein
the wall body is mounted on a vehicle,
the heat medium is a liquid medium,
the predetermined direction is a direction that intersects a vehicle top-bottom direction,
the plurality of tubes are laminated in the vehicle top-bottom direction,
the opening overlapping range is a range of the core portion, biased downward in the vehicle top-bottom direction, and
the inflow port and the outflow port are located below a center position of the core portion in the vehicle top-bottom direction.

6. The heat exchanger according to claim 1, wherein
the wall body is mounted on a vehicle,
the heat medium is a liquid medium,
the predetermined direction is a direction that intersects a vehicle top-bottom direction,
the plurality of tubes are laminated in the vehicle top-bottom direction,
the opening overlapping range is a range of the core portion, biased downward in the vehicle top-bottom direction, and
an upper end of the opening overlapping range in the vehicle top-bottom direction is positioned within a width dimension of the inflow port in the vehicle top-bottom direction.

7. A heat exchanger mounted to a vehicle at a vehicle rear side of a wall body having a ventilation opening through which air flows to the vehicle rear side, the heat exchanger comprising:
a core portion including a plurality of tubes in which a heat medium flows to exchange heat with air having passed through the ventilation opening of the wall body, the plurality of tubes being stacked in a tube stacking direction;
a first header tank connected to one ends of the plurality of tubes to distribute the heat medium into the plurality of tubes, and being provided with an inflow port from which the heat medium flows into the first header tank; and
a second header tank connected to the other ends of the plurality of tubes, into which the heat medium flowing through the tubes collects, wherein
the core portion has an opening overlapping range that overlaps the ventilation opening at the vehicle rear side of the ventilation opening,
the opening overlapping range is a partial range of the core portion in the tube stacking direction, and
at least a part of the inflow port is arranged in an area of the first header tank corresponding to the opening overlapping range of the core portion in the tube stacking direction.

8. The heat exchanger according to claim 7, wherein
the second header tank is provided with an outflow port from which the heat medium collected in the second header tank flow out, and
at least a part of the outflow port is arranged in an area of the second header tank corresponding to the opening overlapping range of the core portion in the tube stacking direction.
